(19) United States
(12) Patent Application Publication
(10) Pub. No.: US 2016/0140527 A1
(43) Pub. Date: May 19, 2016

(54) Digital Contents sales Server and the Method and Program

(71) Applicant: OPTiM CORPORATION, Saga-shi (JP)

(72) Inventor: Shunji SUGAYA, Tokyo (JP)

(21) Appl. No.: 14/789,945

(22) Filed: Jul. 1, 2015

(30) Foreign Application Priority Data
Nov. 17, 2014 (JP) 2014-233015

(51) Int. Cl. G06Q 20/12; G06Q 30/06

(52) U.S. Cl. CPC G06Q 20/123; G06Q 30/0623

(57) ABSTRACT

The present invention provides a digital content sales server supporting a digital content provider in selling digital content. The digital content sales server 200 communicatively connected with a digital content terminal 10. The digital content sales server stores a predetermined digital content, receives a volume range of the digital content, receives an input of the charging amount related to the received volume range, and associates and stores the digital content with the volume range and the charging amount to allow a user to view the digital content through the digital content terminal 10b.

### CROSS-REFERENCE TO RELATED APPLICATIONS

This application is based on and claims the benefit of Japanese Application No. 2014-233015 filed on Nov. 17, 2014, the contents of which are incorporated herein by reference.

### TECHNICAL FIELD

The present invention relates to a digital content sales server, a method of selling digital content, and a program for the digital content sales server.

### BACKGROUND ART

Recently, portable terminals called smartphone and tablet have been widespread. These portable terminals enable users to watch digital contents including electronic books, moving images like movies, and music by installing a predetermined application.

For these digital contents, a technology such as a content delivery system which assigns content ID to the contents for preventing an illegal use of charged contents is disclosed (for example, Patent Document 1).

### CITATION LIST

### Patent Literature

Patent Document 1: JP 2001-325459 A

### SUMMARY OF INVENTION

However, in Patent Document 1, a method of supporting a copyright holder of the digital contents in selling the contents is not disclosed. In the sales of digital contents, a method allowing a user to preview a predetermined range of content free of charge and charging only when the user continues to watch the digital content can encourage a user to purchase the content smoothly. For example, if the digital content is an electronic book, the promotion of the sales can be supported by allowing a user to read a predetermined number of pages free of charge and charging the user for the rest of the pages.

In this context, the objective of the present invention is to provide a digital content sales server, a method of selling a digital content, and a program for the digital content sales server to support digital content providers in selling content.

According to the first aspect of the present invention, a digital content sales server communicatively connected with a digital content terminal, includes:

a digital content storing unit storing a predetermined digital content,

a volume receiver unit receiving a volume range of the digital content,

a charging receiver unit receiving an input of the charging amount related to the received volume range.

The digital content sales server associates and stores the digital content with the volume range and the charging amount to allow a user to view the digital content through the digital content terminal.

According to the first aspect of the present invention, the digital content sales server stores a predetermined digital content, receives a volume range of the digital content, receives the input of the charging amount related to the received volume range, associates and stores the digital content with the volume range and the charging amount to allow a user to view the digital content through the digital content terminal.

The first aspect of the present invention is related to the category of a server, but another category e.g. a method category has similar functions and the effects according to their categories.

According to the second aspect of the present invention, in the digital content sales server according to the first aspect of the invention,

the digital content is an electronic book, the volume receiver unit determines a predetermined number of pages of the electronic book or a predetermined number of lines displayed on a predetermined page as a certain volume range, and the charging receiver unit charges for each of the certain volume range.

According to the third aspect of the present invention, in the digital content sales server according to the first aspect of the invention,

the digital content is a video content,

the volume receiver unit determines a video content output during a predetermined amount of time as a certain volume range, and the charging receiver unit charges for each of the certain volume range.

The present invention can provide a digital content sales server supporting a digital content provider in selling content, a method of selling a digital content, and a program for the digital content sales server.

### BRIEF DESCRIPTION OF DRAWINGS

FIG. 1 shows the overall schematic diagram of a digital content sales system 1.

FIG. 2 shows the functional block diagram of a digital content terminal 10 and a digital content sales server 200.

FIG. 3 shows the flow chart of a digital content sales process executed by the digital content terminal 10 and the digital content sales server 200.

FIG. 4 shows an example image of the input screen (for a movie) displaying a volume range and the charging conditions on a digital content terminal 10a.

FIG. 5 shows an example image of the input screen (for an electronic book) displaying a volume range and the charging conditions on the digital content terminal 10a.

FIG. 6 shows an example image of the screen displaying limitation for the digital content on a digital content terminal 10b.

### DESCRIPTION OF EMBODIMENTS

Hereinafter, embodiments of the present invention will be described with reference to the attached drawings. However, this is illustrative only, and the technological scope of the present invention is not limited thereto.

### Configuration of Digital Content Sales System 1

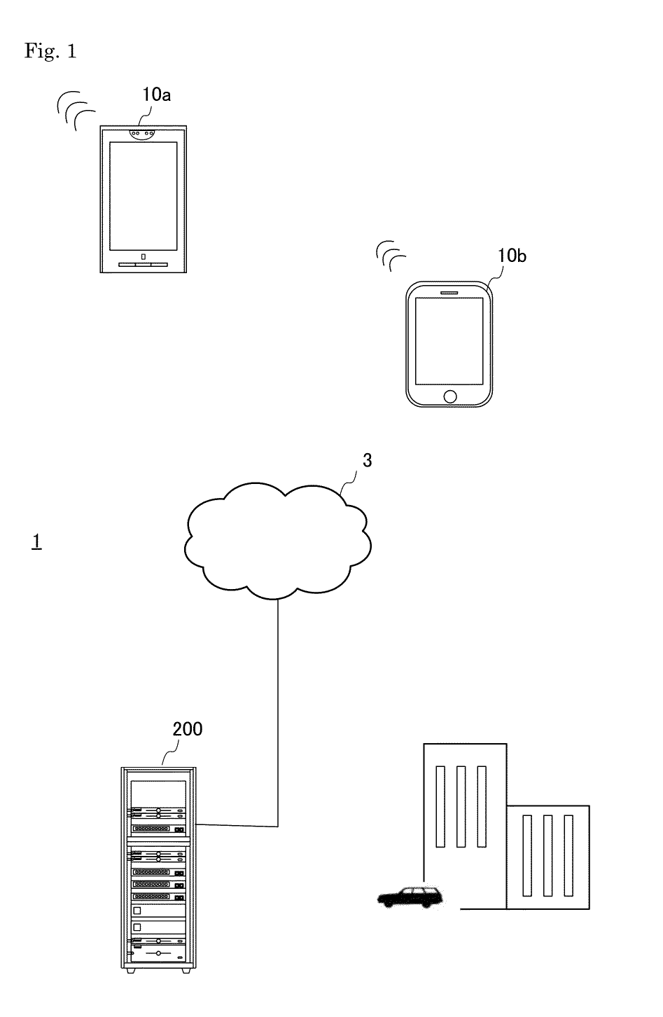

FIG. 1 is a configuration diagram of the digital content sales system 1 according to a preferred embodiment of the present invention. The digital content sales system 1 includes a digital content terminals 10a and 10b (hereinafter simply referred to as “a digital content terminal 10”), a digital content sales server 200, and a public line network 3 (the Internet, the third and the fourth generation communication networks, and the like).

The digital contents are the data that can be watched through a digital content terminal 10. The digital contents may be electronic books, movies, televisions, moving images like videos, music, games, websites, software, applications, texts, comics, animated cartoons, photographs, arts, computer graphics, characters, broadcasting, and e-learning materials.

The digital content terminal 10 has the functions to be mentioned below, can perform data communication, and is an electrical appliance for domestic or business use. The digital content terminal 10 may be an information appliance such as a smartphone, a tablet, a net book terminal, a slate terminal, an electronic book terminal and a potable music player in addition to a mobile terminal, a cellular phone, and a portable terminal. The digital content terminal 10 also maybe a general electrical appliance that can show digital content such as a refrigerator, an audio device, a speaker, a washing machine, a router, a television, a printer, a multifunction printer, a heater, an air conditioner, a telephone, and a recording medium, and a reproducing device in addition to a computer. The digital content terminal 10 has a function to enable Internet communication using a protocol such as TCP/IP.

The digital content terminal 10 may function as a terminal providing digital content (10a) or displaying digital content (10b). That is, both of these functions may be provided in one single terminal.

The digital content sales server 200 receives digital content from a digital content terminal 10a and allows a user to view the contents from another digital content terminal 10b. This server has the following functions described later. The functions executed by the digital content sales server 200 may be separately performed on a plurality of physically divided server.

### Functions

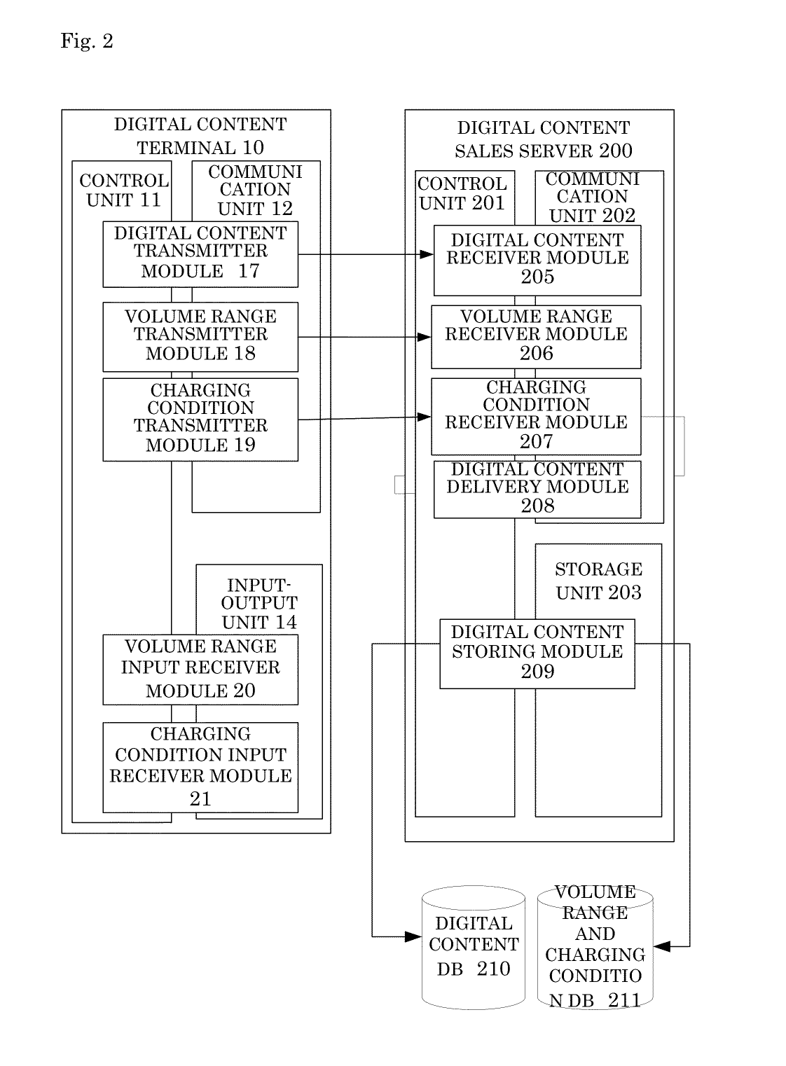

The configuration of each device will be explained with reference to FIG. 2.

The digital content terminal 10 transmits and displays a digital content and includes a control unit 11 provided with a central processing unit (hereinafter referred to as “CPU”), random access memory (hereinafter referred to as “RAM”), and read only memory (hereinafter referred to as “ROM”), and the like and a communication unit 12 including a device communicating with other devices, for example a device connecting to a mobile communication network to perform communication or a Wireless Fidelity or Wi-Fi® enabled device complying with IEEE 802.11.

The digital content terminal 10 also includes a display unit as an input-output unit 14 to output data and images controlled by the control unit. The input-output unit 14 displays the digital content and the data received from the digital content sales server 200. The input-output unit 14 also receives an instruction from a user to transmit the digital content, a specified volume range, and charging conditions etc.

In the digital content terminal 10, the control unit 11 reads a predetermined program and cooperates with the communication unit 12 to run a digital content transmitter module 17, a volume range transmitter module 18, and a charging condition transmitter module 19. Moreover, the control unit 11 reads a predetermined program and cooperates with the input-output unit 14 to run a volume range input receiver module 20, and a charging condition input receiver module 21.

The program read in the digital content terminal 10 may be an application program installed in the digital content terminal 10. The application program, at installation, may have a function to register the user identifier of a user operating the digital content terminal 10. The digital content terminal 10 appropriately receives an input from a user such as an email address, a short message address, a telephone number, a product ID, and an ID associated with the application, etc. that are used to receive electronic book contents and the data from the digital content sales server 200. Then the digital content terminal 10 transmits the received input to the digital content sales server 200 for registration.

The digital content sales server 200, in the same way as the digital content terminal 10, includes a control unit 201 provided with a CPU, a RAM, and a ROM, and the like; and a communication unit 202 provided with a device that performs data communication with other computers, such as Wi-Fi® enabled device complying with, for example, IEEE802.11, and a device connectable with cables. The digital content sales server 200 also includes a data storage unit such as a hard disk, semiconductor memory, a recording medium, or a memory card as a storage unit 203 storing data, files and database tables.

In the digital content sales server 200, the control unit 201 reads a predetermined program and cooperates with the communication unit 202 to run a digital content receiver module 205, a volume range receiver module 206, a charging condition receiver module 207, and a digital content delivery module 208. Moreover, the control unit 201 reads a predetermined program and cooperates with the storage unit 203 to run a digital content storing module 209.

A digital content DB 210 and a volume range and charging condition DB 211 may be external database servers. Original digital contents are stored in the digital content DB 210. The volume range and the charging condition associated with original digital content is stored in the volume range and charging condition DB 211.

Here, the volume range is a part of the original digital content, specified by the copyright holder of the digital content, and allowed to be free of charge. For example, when the digital content is movie, the range is a predetermined time (with hours, minutes, and seconds) after start of the movie. When the digital content is an electronic book, the range is a predetermined number of pages, a predetermined number of lines or rows on a predetermined page. The volume range may be limited by for example, time, pages, areas, volume, a game progress state, a function of software, a predetermined web page, etc. In addition, the charging condition is charging condition for the volume range specified by a copyright holder of digital content, for example specific charging amount or charging rate.

### Digital Content Sales Process

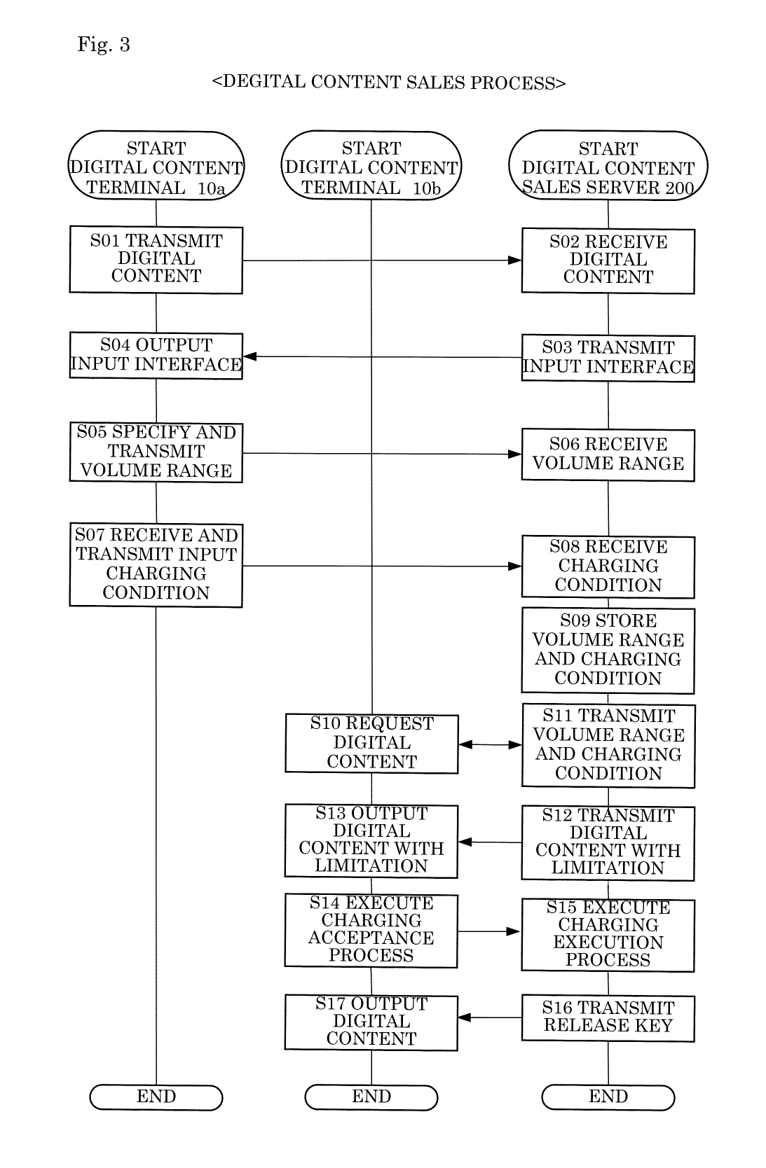

FIG. 3 is a flow chart of the digital content sales process executed by the digital content terminals 10(a,b) and the digital content sales server 200. The process executed by the module of each of the above-mentioned devices will be explained together with the present process.

First, the digital content transmitter module 17 of the digital content terminal 10a transmits (uploads) a digital content to the digital content sales server 200 (Step S01) in response to the operation from the copyright holder of the digital content. Accordingly, the digital content receiver module 205 receives the transmitted digital content and stores it in the digital content DB 210 (Step S02).

Next, the volume range receiver module 206 and the charging condition receiver module 207 transmit an input interface for receiving an input of a volume range and charging conditions from the copyright holder to the digital content terminal 10a (Step S03). Accordingly, the volume range input receiver module 20 and the charging condition input receiver module 21 receives and displays the transmitted input interface (Step S04).

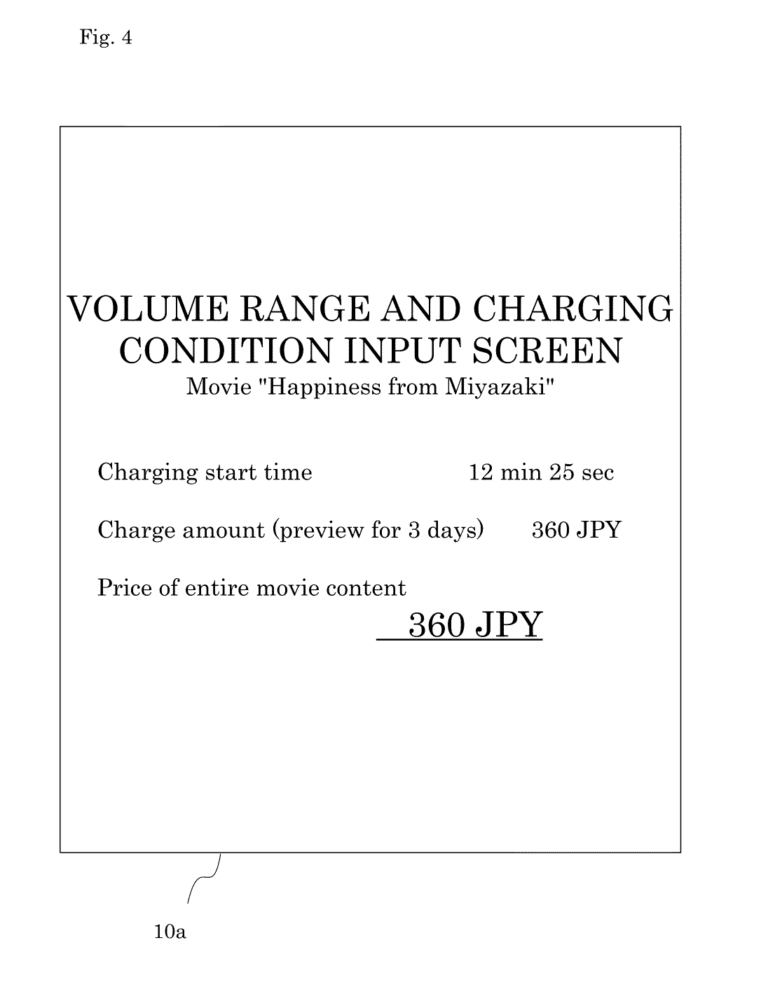

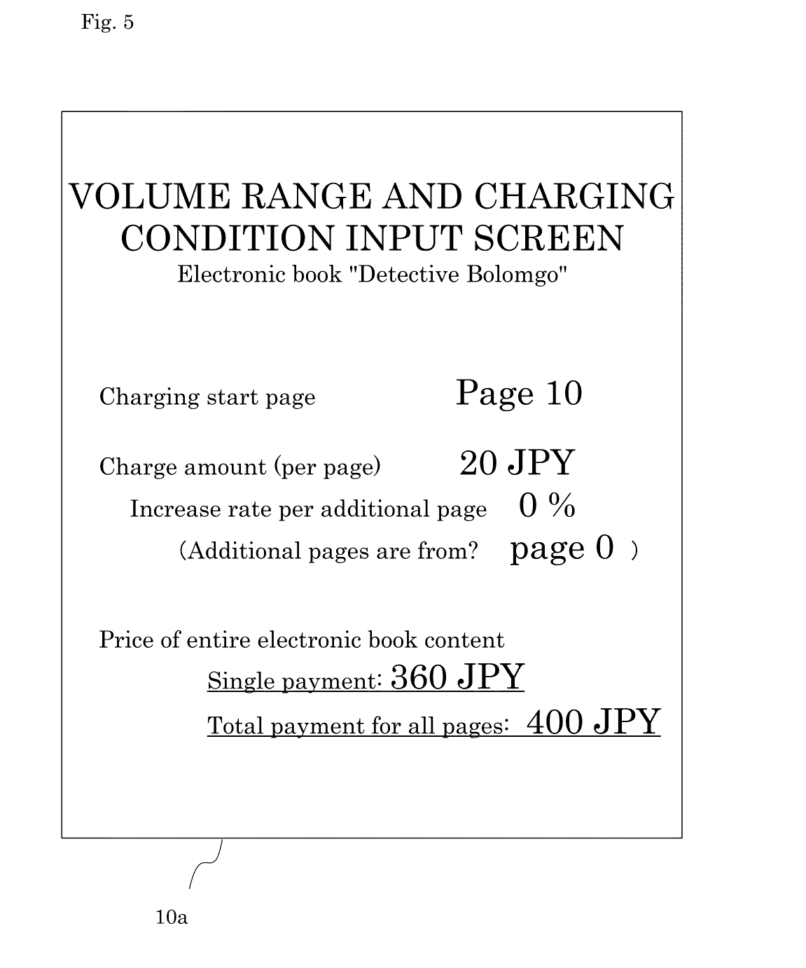

FIGS. 4 and 5 show the example images of the screen displaying the input interface on the digital content terminal 10a. FIG. 4 shows an example screen when the digital content is a movie. The charging start time falls within the volume range, which is 12 minutes and 25 seconds. When the charge amount meets the charging conditions, preview after the volume range (12 minutes 25 seconds) is charged at 360 JPY.

On the other hand, FIG. 5 shows an example screen when the digital content is an electronic book. The charging start page falls within the volume range, which is page 10. When the charge amount meets the charging conditions, preview after the volume range page 10 is charged at 20 JPY per page. Besides these charging conditions described above, copyright holder can specify the charge amount as 360 JPY in a single payment and an increase rate per page. That is, if the increase rate per page is specified as 5% and if the start page is 25, the charging amount of the page 25 is 20 JPY×105% =21 JPY (per page), and the charging amount of the page 26 is 22 yen (after rounding off to the closest number).

The volume range input receiver module 20 and the charging condition input receiver module 21 receives the input of a volume range and charging conditions, and the volume range transmitter module 18 and the charging condition transmitter module 19 transmits the received data to the digital content sales server 200 (Steps S05 and S07). Accordingly, the volume range receiver module 206 and charging condition receiver module 207 of digital content sales server 200 receives the volume range and the charging conditions, accepts the input (Steps S06 and S08) and associates and stores the digital content with the volume range and the charging conditions in the volume range and charging condition DB 211.

In the process described above, the transmitted digital content is stored to be allowed for preview of within the input volume range and under the input charging conditions through the digital content terminal 10b. The digital content terminal 10b, which is used to view digital content, requests the download of a digital content from the digital content sales server 200 in response to a user's request (Step S10).

Accordingly, the digital content delivery module 208 of the digital content sales server 200 transmits the volume range and the charging conditions of the requested digital content in addition to the explanation of the content (Step S11) and explicitly shows them to the user of the digital content terminal 10b. In addition, when the user requests the digital content, the digital content delivery module 208 transmits the digital content with limitation of the volume range and the charging conditions to the digital content terminal 10b (Step S12). The digital content input-output module (not shown in the figures) outputs the received digital content with limitation (Step S13).

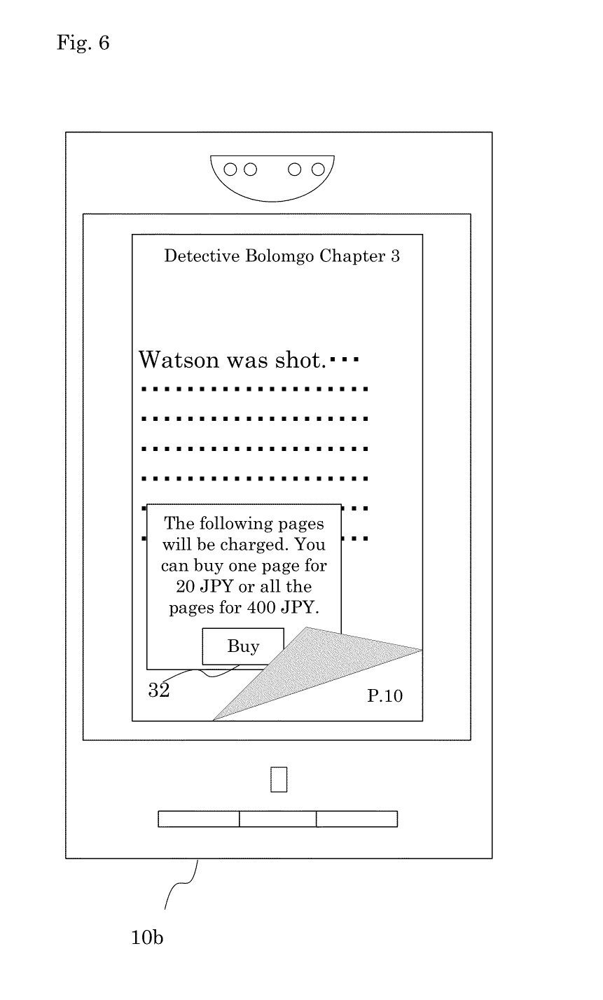

The output of a digital content with limitation means that a digital content within the specified volume range is output without any charge and that the content without the volume range is not output. For example, as shown in FIG. 6, in the case of electronic book content, the volume range (charging for the pages from page 10) and the charging condition (20 JPY per page) according to above-mentioned FIG. 5, the charging condition is displayed to encourage the user to pay the charge when the page 10 is output (Step S14).

Accordingly, when the user, who is watching the digital content terminal 10b, instructs the charging process (for example, presses the Buy button 32 in FIG. 6) (Step S14), the charging condition receiver module 207 executes the charging process (Step S15). When a charging process is completed, the digital content sales server 200 transmits a key that releases the limitation of digital content to the digital content terminal 10b (Step S16). The digital content terminal 10b receives the key, releases the limitation, and outputs the digital content (Step S17).

The above-mentioned example assumes that a user views a digital content because the movie and the electronic book are mainly described as the examples of digital content. But when the digital content is game and software, etc. the progress state of the digital content varies in response to the user's operation, whether the volume range is reached or not is determined based on the progress status.

To achieve the means and the function that are described above, a computer (including CPU, an information processor, and various terminals) reads and executes a predetermined program. For example, the program is provided in the form recorded in a computer-readable medium such as a flexible disk, CD (CD-ROM, etc.), and DVD (DVD-ROM, DVD-RAM, etc.). In this case, a computer reads a program from the recording medium, forwards and stores the program to and in an internal or an external storage, and executes it. The program may be previously recorded in, for example, a storage (recording medium) such as a magnetic disk, an optical disk, and a magneto-optical disk and provided from the storage to a computer through a communication line.

The embodiment of the present invention is described above. However, the present invention is not limited to the above-mentioned embodiment. The effect described in the embodiment of the present invention is only the most preferable effect produced from the present invention. The effect of the present invention is not limited to those described in the embodiment of the present invention.

### REFERENCE SIGNS LIST

1 digital content sales system

10a and 10b digital content terminal

200 digital content sales server

1. A digital content sales server communicatively connected with a digital content terminal, comprising:
a digital content storing unit storing a predetermined digital content;
a volume receiver unit receiving a volume range of the digital content; and
a charging receiver unit receiving an input of the charging amount related to the received volume range;
wherein the digital content sales server associates and stores the digital content with the volume range and the charging amount to allow a user to view the digital content through the digital content terminal.

2. The digital content sales server according to claim 1,
wherein the digital content is electronic book, the volume receiver unit determines a predetermined number of pages of the electronic book or a predetermined number of lines displayed on a predetermined page as a certain volume range; and the charging receiver unit charges for each of the certain volume range.

3. The digital content sales server according to claim 1,
wherein the digital content is the video,
the volume receiver unit determines a video content output during a predetermined amount of time as a certain volume range, and the charging receiver unit charges for each of the certain volume range.

4. A method executed by a digital content sales server communicatively connected with a digital content terminal, the method comprising the steps of:
storing a predetermined digital content;
receiving a volume range of the digital content;
receiving an input of the charging amount related to the received volume range; and
associating and storing the digital contentwith the volume range and the charging amount to allow a user to view the digital content through the digital content terminal.

5. A computer program product for use in a digital content sales server communicatively connected with a digital content terminal, comprising a non-transitory computer usable medium having a set of instructions physically embodied therein, the set of instructions including computer readable program code, which when executed by the digital content sales server causes the information processing unit to:
store a predetermined digital content;
receive a volume range of the digital content;
receive an input of the charging amount related to the received volume range; and
associate and store the digital content with the volume range and the charging amount to allow a user to view the digital content through the digital content terminal.
